(19) United States
(12) Patent Application Publication
(10) Pub. No.: US 2003/0137723 A1
(43) Pub. Date: Jul. 24, 2003

(54) Transmission device for a surgical microscope

(76) Inventor: Ulrich Sander, Rebstein (CH)

Correspondence Address: George L. Snyder, Jr., Hodgson Russ LLP, Suite 2000, One M&T Plaza, Buffalo, NY, 14203-2391, US

(21) Appl. No.: 10/336,325

(22) Filed: Jan. 2, 2003

(30) Foreign Application Priority Data
Jan. 22, 2002 (DE) 102 02 125.2

(51) Int. Cl. G02B 21/00

(52) U.S. Cl. 359/380; 359/368; 359/385

(57) ABSTRACT

The invention concerns a transmission device for control of an optical viewing unit, for example a surgical microscope (1), in which control or functional checking for the microscope (1)—such as zoom, focus, working distance, positioning, tilt, pivot, video, etc.—is accomplished by bidirectional (preferably electromagnetic) radiation (8) between a first transmit/receive unit of an electronic control system (3) and a second transmit/receive unit (5) connected to the microscope (1).

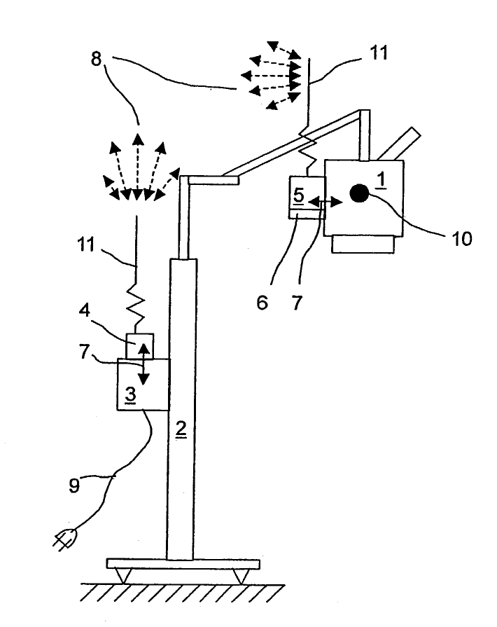

### CROSS REFERENCE TO RELATED APPLICATIONS

This application claims priority of the German patent application 102 02 125.2 filed Jan. 22, 2002 which is incorporated by reference herein.

### FIELD OF THE INVENTION

The invention concerns a transmission device for an optical viewing device, for example a (surgical) microscope.

### BACKGROUND OF THE INVENTION

In currently common surgical microscopes, the transmission of data for the microscope—such as zoom, focus, working distance, positioning, tilt, pivot, video, etc.—is accomplished via electrical cables, so that a plurality of cables must be routed in the microscope.

The physical integration of the power and data lines that was disclosed in EP 1 124 150 A1, or the “Foot switch with radio control,” data sheet of Steute Medizintechnik Co., Löhne (DE) (5 pages, dated Jul. 20, 2000), may be cited as examples for the reduction of connecting cables. The number of cables can also be reduced using CAN (Controller Area Network) technology.

With its “OP-System 1120,” the Maquet Co., Rastatt (DE) (brochure reg. 6535.005.25.500 6.92 E&B) offers infrared control systems for modifying the position of operating tables.

The inventor has recognized that these known systems are disadvantageous in terms of the following aspects:

a) The cables result in limitations on the freedom of movement of the surgical microscope.

b) Complex design solutions are needed in order to stow the cables in the stand in break-resistant and integrated fashion.

c) The radii of curvature of the cables cannot be made arbitrarily small. Forces are thus exerted on the rotary joints.

### SUMMARY OF THE INVENTION

It is the object of the invention to create a transmission device which transmits the data for the microscope from the electronic system to the microscope and the control devices without the power and data cables that are currently usual.

This object is achieved by way of the transmission device described below.

In the operating state, the control data and/or measured data for the microscope, for example zoom, focus, working distance, positioning, tilt, pivot, video, etc., are transferred from the electronic control system by means of a transmit/receive unit by bidirectional (preferably electromagnetic) radiation to a transmit/receive unit mounted on the microscope. A wireless surgical microscope with broadcast transmission can thereby be created.

The electronic control system and its transmit/receive unit not only can be mountable on the stand, but also can be configured to be independently installable.

The bidirectional broadcast transmission can be accomplished both as digital or analog electromagnetic radiation and as infrared or ultrasonic radiation.

In a further embodiment, the bidirectional configuration of the broadcast transmission according to the present invention also makes possible the transfer of data generated by conventional handles or, for example, by a handheld mouse with trackball or by a mouse pad.

In order to eliminate radiation that is harmful to patients, surgeons, and/or other electronic devices, the transmitting units are shielded with respect to specific regions. In addition, the radiation cone can be kept very narrow by means of a directed beam transmission. The range of the radiation can deliberately be kept short so that distant external devices are influenced as little as possible.

The following improvements are achieved by way of the transmission device described above:

No limitation on the freedom of movement of the surgeon or the carrier system for optical instruments.

A mechanically simple design solution.

Ability to avoid interference or interruption to the cables, which can result in failure of the unit.

With electromagnetic or ultrasonic radiation, there is no risk of shadowing as with infrared.

### DETAILED DESCRIPTION OF THE INVENTION

The drawings schematically depict a preferred transmission device according to the present invention. Data 7 (for example zoom, focus, working distance, positioning, tilt, pivot, video transmission, etc.) generated by an electronic control system 3 of microscope 1 are transferred via a transmit/receive unit 4 connected to electronic control system 3, by electromagnetic radiation 8, to a transmit/receive unit 5 mounted on microscope 1. Transmit/receive unit 4 of electronic control system 3 is, for example, mounted on a stand 2, and is powered via a power connection 9 of electronic control system 3. The bidirectional broadcast transmission 8 can be accomplished both as digital and/or analog electromagnetic radiation that is radiated and received via antennas 11, and/or as ultrasonic waves. From transmit/receive unit 5 of microscope 1, control data 7 go to positioning elements of microscope 1.

In order to eliminate the power supply cable of transmit/receive unit 5 on microscope 1, said transmit/receive unit 5 can be powered by way of a rechargeable battery 6 that optionally is chargeable via solar cells, or by battery cells.

PARTS LIST

| | |
|---|---|
| 1 | Microscope |
| 2 | Stand |
| 3 | Electronic control system |
| 4 | Transmit/receive unit of (3) |
| 5 | Transmit/receive unit of (3) connected to (1) |
| 6 | (Rechargeable) battery/ies |
| 7 | Data (control data) |
| 8 | Bidirectional/electromagnetic radiation (broadcast transmission) |
| 9 | Power connection |
| 10 | Handle(s) |
| 11 | Antenna(e) |

What is claimed is:

1. A device for control and functional monitoring of a surgical microscope, said device comprising:
an electronic control system for generating and processing data signals to control a plurality of functions of said microscope;
a first transmit/receive unit adapted for connection to said electronic control system; and
a second transmit/receive unit adapted for connection to said microscope;
wherein said data signals are communicated bidirectionally between said first and second transmit/receive units by radiation.

2. The device according to claim 1, wherein said plurality of functions of said microscope includes a zoom function.

3. The device according to claim 1, wherein said plurality of functions of said microscope includes a focus function.

4. The device according to claim 1, wherein said plurality of functions of said microscope includes a working distance function.

5. The device according to claim 1, wherein said plurality of functions of said microscope includes a positioning function.

6. The device according to claim 1, wherein said plurality of functions of said microscope includes a tilt function.

7. The device according to claim 1, wherein said plurality of functions of said microscope includes a pivot function.

8. The device according to claim 1, wherein said plurality of functions of said microscope includes a video function.

9. The device as defined in claim 1, wherein said data signals include both digital and analog signals communicated by electromagnetic radiation.

10. The device as defined in claim 1, wherein at least some of said data signals are communicated by light waves.

11. The device as defined in claim 10, wherein said light waves are in the infra-red spectral region.

12. The device as defined in claim 1, wherein at least some of said data signals are communicated by sound waves.

13. The device as defined in claim 12, wherein said sound waves are ultrasonic sound waves.

14. The device as defined in claim 1, further comprising means for partially shielding said first and second transmit/receive units to avoid undesired emissions.

15. The device as defined in claim 1, wherein transmission of said data signals is accomplished by directed radiation.

16. The device as defined in claim 1, wherein said surgical microscope is mounted on a stand and said first transmit/receive unit is optionally installable on said stand.

17. The device as defined in claim 1, wherein said microscope includes a pair of handles, and said device further comprises switches and control elements provided on said handles for transmitting electronic signals to said first and second transmit/receive units.

18. The device as defined in claim 17, wherein said switches and control elements can be brought into signal connection with external devices.

19. The device as defined claim 1, wherein energy is supplied to said second transmit/receive unit by batteries.

20. The device as defined in claim 19, wherein energy is also supplied to said second transmit/receive unit by solar cells operating in conjunction with said batteries.
